(19) United States
(12) Patent Application Publication
(10) Pub. No.: US 2008/0007949 A1
(43) Pub. Date: Jan. 10, 2008

(54) Multiple laser light source

(75) Inventors: Robin C. Swain, Trabuco Canyon, CA (US); Mike Wyatt, Rancho Santa Margarita, CA (US)

Correspondence Address: Brian F. Swienton;Newport Corporation, 1791 Deere Avenue, Irvine, CA, 92606, US

(73) Assignee: Newport Corporation, Irvine, CA (US)

(21) Appl. No.: 11/823,150

(22) Filed: Jun. 26, 2007

Related U.S. Application Data
(60) Provisional application No. 60/819,451, filed on Jul. 7, 2006.

(51) Int. Cl. F21V 14/00

(52) U.S. Cl. 362/235

(57) ABSTRACT

The present application discloses a multiple laser light source and includes a housing having a housing body defining at least one inner passage therein, at least one laser support device configured to be coupled to the housing body, two or more laser devices coupled to the laser support device each configured to output an optical signal, and a beam director coupled to the housing body and configured to receive the optical signals from the laser devices and controllable output the optical signals to a desired focal point.

### CROSS REFERENCE TO RELATED APPLICATIONS

The present application claims priority to U.S. Provisional Patent Application Ser. No. 60/819,451, filed Jul. 7, 2006, the contents of which are hereby incorporated by reference in its entirety herein.

### BACKGROUND

Laser devices and systems are used in a variety of application. For example, these devices are commonly used in materials processing, therapeutic applications, and research. Conventional lasers are configured to emit radiation at a single wavelength. Increasingly, however, laser systems capable of emitting radiation at multiple wavelengths simultaneously are needed for a number of applications.

Currently, optical systems incorporating multiple laser devices are used to emit radiation at multiple wavelengths. Typically, multiple laser devices are positioned within an optical system and configured to emit radiation multiple beam directors. The beam directors direct the incident beam to one or more locations within the optical system. In some applications, the beam directors are movable, such as mirrors positioned on a spinning mount. While these systems have proven useful, in the past, a number of shortcomings have been identified. For example, these optical systems tend to be quite large. In some applications, such as medical applications or flow cytometry, the physical size of the optical systems currently available renders these systems unusable in most applications. Further, the

Thus, in light of the foregoing, there is an ongoing need for a compact multiple laser light source configured for use in variety of applications.

### SUMMARY

Various embodiments a multiple laser light source are disclosed herein. In one embodiment, the present application is directed to a multiple laser light source and includes a housing having a housing body defining at least one inner passage therein, at least one laser support device configured to be coupled to the housing body, two or more laser devices coupled to the laser support device each configured to output an optical signal, and a beam director coupled to the housing body and configured to receive the optical signals from the laser devices and controllable output the optical signals to a desired focal point.

In another embodiment, the present application is directed to a multiple laser light source and includes a housing having a housing body defining at least one inner passage therein, at least one laser support device configured to be coupled to the housing body, two or more laser devices coupled to the laser support device each configured to output an optical signal, and a beam director coupled to the housing body and configured to receive the optical signals from the laser devices and output the optical signals to a desired focal point, the beam director having at least one receiving surface and at least one output surface formed thereon, the receiving surface and output surface in communication with at least one alignment mechanism permitting the user to adjust the output the optical signals.

In another embodiment, the present application is directed to a multiple laser light source and includes a housing having a housing body defining at least one inner passage therein, at least one laser support device configured to be coupled to the housing body, two or more laser devices coupled to the laser support device each configured to output an optical signal, a beam director coupled to the housing body and configured to receive the optical signals from the laser devices and output the optical signals to a desired focal point, at least one receiving surface and at least one output surface formed on the beam director, the receiving surface and output surface in communication with at least one alignment mechanism permitting the user to adjust the output the optical signals, and at least one optical element coupled to the beam director and configured to controllably modulate the output from the laser device.

Other features and advantages of the embodiments of a multiple laser light source as disclosed herein will become apparent from a consideration of the following detailed description.

### BRIEF DESCRIPTION OF THE DRAWINGS

Various multiple laser light sources will be explained in more detail by way of the accompanying drawings, wherein:

FIG. 1 shows a elevated perspective view of a multiple laser light source;

FIG. 2 shows an exploded view of an embodiment of a multiple laser light source;

FIG. 3 shows an elevated perspective view of an embodiment of a laser support device form use with a multiple laser light source;

FIG. 4 shows a front view of an embodiment of a support device having multiple laser devices affixed thereto positioned within the housing of a multiple laser light source;

FIG. 5 shows an elevated perspective view of an embodiment of a beam director for use with a multiple laser light source;

FIG. 6 shows a front view of an embodiment of a beam director positioned within the housing of a multiple laser light source;

FIG. 7 shows an elevated perspective view of an embodiment of beam director coupled to a laser support device for use within a multiple laser light source;

FIG. 8 shows a front view of a multiple laser light source including a housing having laser support device and beam director positioned therein; and

FIG. 9 shows a cross-sectional view of the multiple laser light source shown in FIG. 8 viewed along the line A-A.

### DETAILED DESCRIPTION

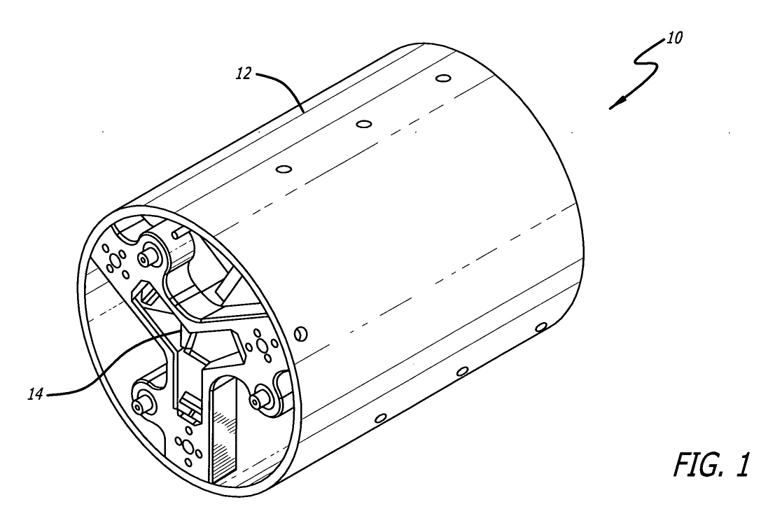

FIG. 1 shows an embodiment of a multiple laser light source. As shown, the multiple laser light source 10 includes a housing 12 having a beam director 14 secured thereto. In the illustrated embodiment, the housing 12 comprises a cylindrical body, although those skilled in the art will appreciate that the housing body may be formed in any variety of shapes and sizes as desired. In the illustrated embodiment the housing 12 and/or the beam director 14 are manufactured from aluminum. Any variety of materials may be used to form the housing 12 and/or the beam director 14, including, without limitation, steel, titanium, copper, tungsten, copper-tungsten alloys, metallic alloys, polymers, ceramic materials, composite materials, glass-reinforced polymers, elastomers, and the like. For example, the housing 12 and/or the beam director 14 may be constructed of materials configured to conduct heat from one or more devices positioned within the housing 12 and/or the beam director 14.

Referring again to FIG. 1, like the housing 12, the beam director 14 may be manufactured from any variety of materials in any variety of shapes and/or sizes. In the illustrated embodiment the beam director 14 comprises a Y-shaped element positionable within the housing 12. In an alternate embodiment, the beam director 14 need not be positioned within the housing 12. Rather, the beam director 14 may be coupled to the exterior of the housing 12. Further, the beam director 14 may be non-detachably coupled to or detachably coupled to the housing 12.

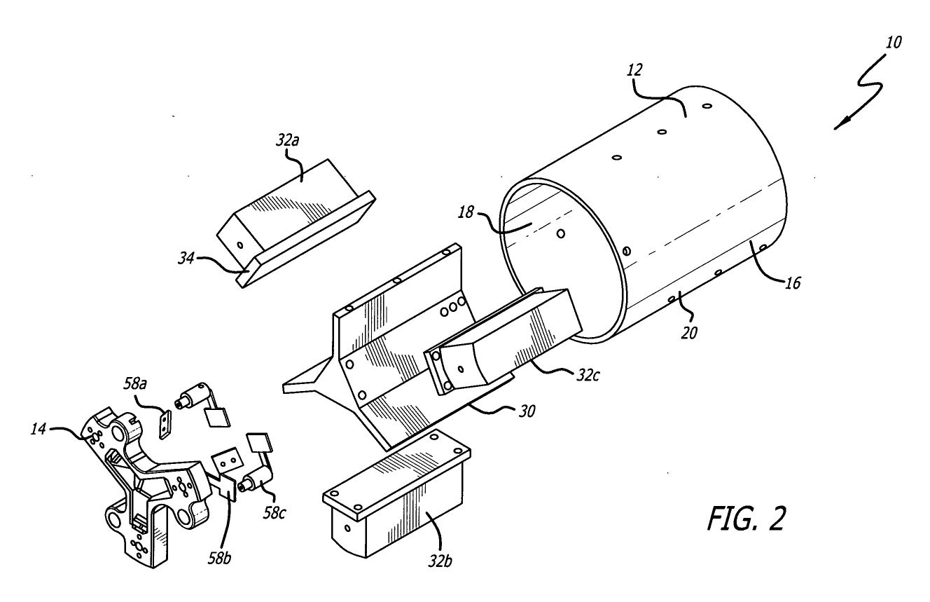

FIG. 2 shows an exploded view of an embodiment of a multiple laser light source. As shown, the housing 12 of the multiple laser light source 10 comprises at least one housing body 16 defining at least one inner passage 18 therein. Further, one or more orifices 20 may be formed in the housing body 16. For example, at least one orifice 20 may be configured to receive one or more fastening devices therein, thereby permitting one or more devices to be coupled to the housing body 16 or the housing 12 to be coupled to one or more devices. For example, the orifice 20 may be used to couple one or more laser mounts to the housing 12. In an alternate embodiment, at least one orifice 20 may be configured to couple to a cooling system or device. For example, one or more fluid sources may be coupled to one or more orifices 20 formed on the housing body 16. As such, the multiple laser light source 10 may be convection cooled, liquid cooled, fluid cooled, or the housing 12 may incorporate one or more chillers, fans, or alternate cooling devices therein. In another embodiment, the housing body 16 may include one or more surface irregularities formed thereon, thereby increasing the surface area thereof. Exemplary surface irregularities include, without limitation, fins, blades, or extensions configured to improve convection cooling of one or more device positioned within the housing 12 or in close proximity thereto.

Referring again to FIG. 2, at least one laser support device 30 may be positioned within the housing 20 and configured to have at least one laser device 32 coupled thereto. In the illustrated embodiment a first laser device 32a, a second laser device 32b, and a third laser device 32c are coupled to the laser support device 30. Those skilled in the art will appreciate that any number or variety of laser devices 32 may be coupled to the laser support device 30. For example, in one embodiment the laser devices 32a-32c comprise diode laser devices. Alternate laser devices and amplifiers include, without limitation, gas lasers, solid state lasers, diode-pumped solid state lasers, dye lasers, organic lasers, fiber lasers, disc lasers, vertical cavity surface emitting lasers, and the like. Optionally, at least one non-laser device may be coupled to the laser support device 30, including, without limitation, light emitting diodes, incandescent lamps, flash lamps, and the like. In one embodiment, the laser devices 32a-32c are the same laser devices. In an alternate embodiment, at least one laser device 32 may differ the other laser devices 32. For example, laser device 32c may comprise a diode laser while laser devices 32aand 32b comprise solid state lasers. As such, laser devices 32A-32C may be configured to emit the light having the same or different wavelengths, powers, brightness, repetition rate, beam quality, beam profile, and the like.

Optionally, the laser device 32a-32c may be configured to irradiate optical signals having the same wavelength. In an alternate embodiment, at least one laser device 32 may irradiate an optical signal at a wavelength different than other laser devices 32 used in the multiple laser light source 10. For example, laser device 32a may output an optical signal at 750 nm, laser device 32b may output an optical signal at 560 nm, and laser device 32c may output an optical signal at 480 nm. Optionally, any number of laser devices 32 may be used with the multiple laser light source 10. In the illustrated embodiment three laser devices 32a-32c are used, however, the multiple laser light source 10 may be constructed to include any number of laser devices therein.

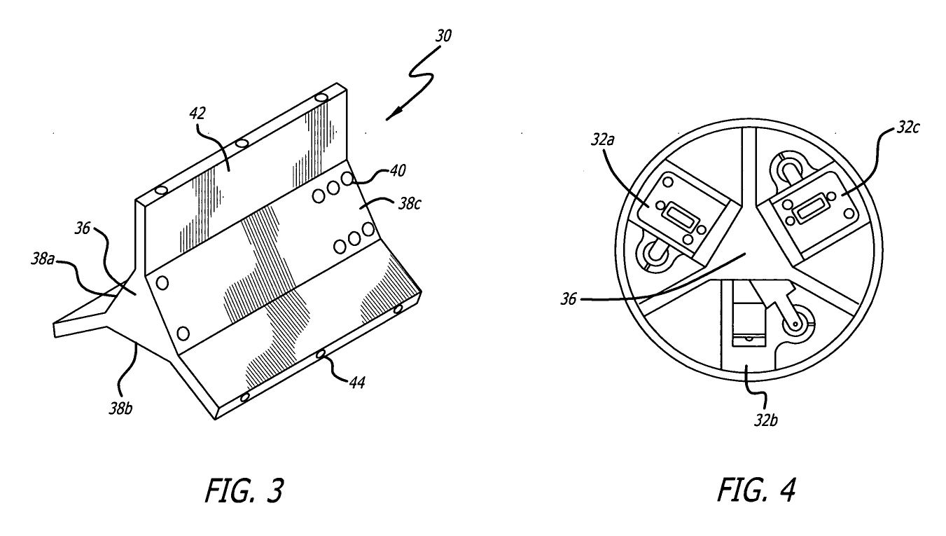

FIGS. 2-4 show various views of an embodiment of a laser support device 30 for use with a multiple laser light source 10. As shown, the laser support device 30 includes a support device body 36 having one or more laser device receivers 38 formed thereon. In the illustrated embodiment, the support device body 36 includes a first laser device receiver 38a, a second laser device receiver 38b, and third laser device receiver 38c formed thereon. One or more orifices 40 may be formed in one or more of the laser device receivers 38a-38c. In one embodiment, a mounting member 34 positioned on or otherwise coupled to the laser device 32 may be coupled to the support device body 36 by positioning one or more fasteners coupled to the mounting member 34 within the orifice 40. For example, the orifice 40 may be threaded to receive a threaded fastener therein. As such, the laser devices 32a-32c may be detachably coupled to the laser support device 30. In another embodiment, the laser devices 32a-32c may be non-detachably coupled to the laser support device 30. Optionally, at least one orifice 40 may be used to provide coolant to the support device body 36, at least one laser device 32 coupled thereto, or both. As such, the support device body 36 may include one or more channels formed therein to effectuate fluid flow therethrough. Optionally, one or more power supplies may be coupled to or otherwise in communication with the housing 12 and configured to provide power to one or more devices forming the multiple laser light source 12.

Referring again to FIGS. 2-4, at least one coupling member 42 may be formed on or otherwise coupled to the support device body 36. For example, the coupling member 42 may be configured to couple the laser support device 30 to the housing 12. As such, the coupling member 42 may include one or more coupling member orifices 44 formed thereon. In one embodiment, the laser support device 30 is detachably coupled to the housing 12 using one or more fasteners. In an alternate embodiment, the laser support device 30 is non-detachably coupled to the housing 12. The coupling member 42 may also assist in the thermal management of the multiple laser light source 10 by conducting heat away from one or more laser devices 32a-32c.

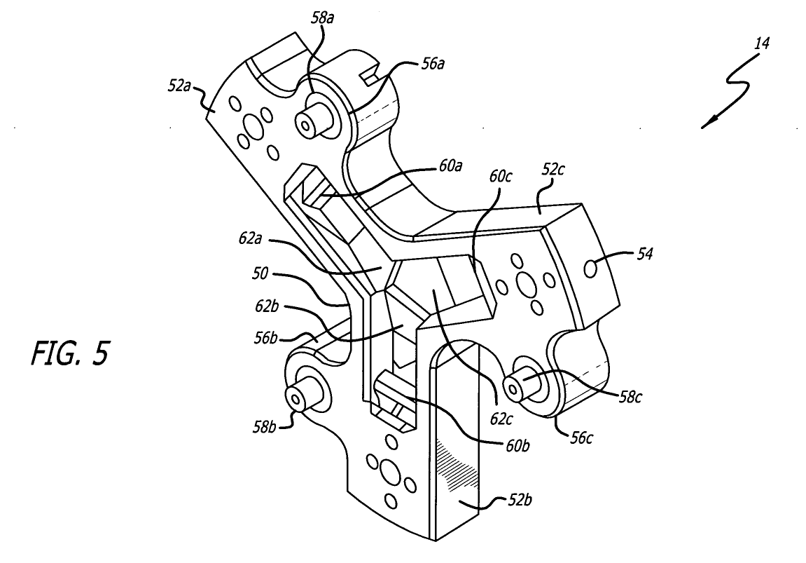

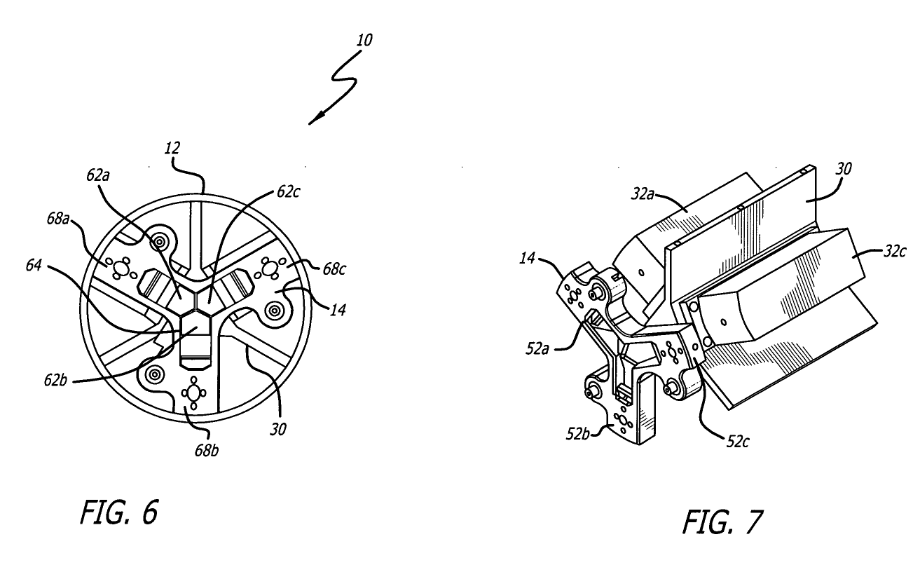

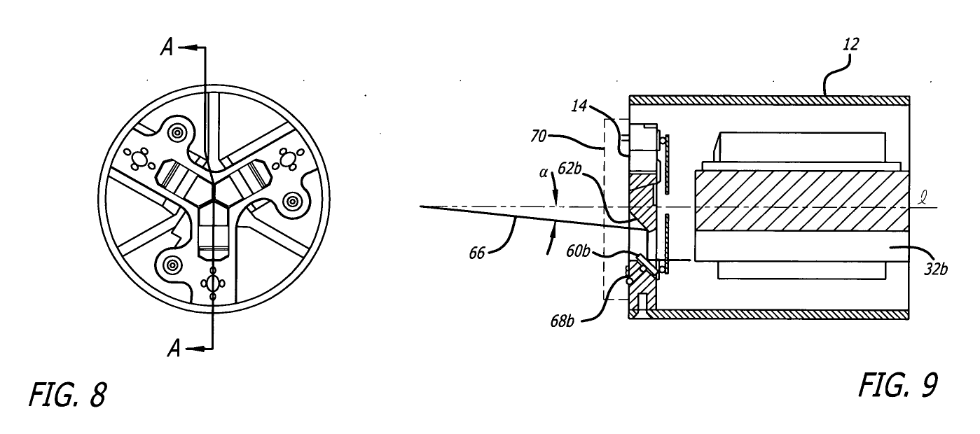

FIGS. 2 and 5-9 show various views of an embodiment of a beam director 14 for use with a multiple laser light source 10. As shown, the beam director 14 comprises a director body 50 having one or more body extensions 52a-52c formed thereon. In the illustrated embodiment, three body extensions 52a-52c are shown, although those skilled in the art will appreciate that any number of body extensions 52 may be formed on the director body 50. Optionally, at least one coupling orifice 54 may be formed on at least one body extension 52, thereby permitting the beam director 14 to be coupled to the housing 12.

Referring again to FIGS. 2 and 5-9, one or more optical device receivers 56 may optionally be formed on the director body 50. In the illustrated embodiment, optical devices receivers 56a-56c are formed on the director body 50, though any number of optical device receivers 56 may be formed thereon. The optical device receivers 56a-56c may be configured to receive at least one optical device therein. In the illustrated embodiment, optical devices 58a-58c, respectively, are positioned within the optical device receivers 56a-56c, respectively. Exemplary optical devices 58 include, for example, shutters, modulators, prisms, lenses, filters, beam twisters, optical crystals, polarizers, mirrors, gratings, and the like. For example, the optical devices 58a-58c may comprise shutters thereby permitting a user to irradiate one, two, or three optical signals from the multiple laser light source simultaneously, sequentially, or in any combination thereof.

As shown in FIGS. 2 and 5-9, the beam director 14 further includes at least one receiving surface 60 configured to receive an optical signal from at least one laser device 32 and direct the optical signal to an output surface 62 formed thereon. In one embodiment at least one of the receiving surface 60 and output surface 62 comprises a mirror. Optionally, the receiving surface 60 and/or output surface 62 may comprise a reflective surface. In the illustrated embodiment, an optical signal irradiated by laser device 32a is directed by the receiving surface 60a to the output surface 62a, which outputs the signal from the multiple laser light source 10. Similarly, an optical signal irradiated by laser device 32b is directed by the receiving surface 60b to the output surface 62b while an optical signal irradiated by laser device 32c is directed by the receiving surface 60a to the output surface 62c, each of which are directed out of the multiple laser light source 10. In one embodiment, at least one of the receiving surface 60 or the output surface 62 includes an alignment mechanism 68 configured to permit a user to adjust the angular displacement of an output signal 66 relative to an optical axis l. For example, FIG. 9 shows a cross-sectional view of a beam director 14 coupled to a housing 12. As shown, the receiving surface 60b formed on body extension 52b of the beam director 14 includes an alignment mechanism 68b, while the output surface 62a is fixed at an angle approximating 45 degrees relative to the optical axis l. By actuating the alignment mechanism 68b the user may alter the angular displacement a an output signal 66 relative to an optical axis l. Should the angle of the receiving surface 60b be equivalent to the angle of the output surface 60c the resulting output signal will be parallel to the optical axis I. For example, the angle of the receiving surface 60b may be adjustable from about 25 degrees to about 65 degrees, relative to the optical axis I. As such, the user may easily adjust the multiple laser light source 10 to produce output signals having large angular displacements a from the optical axis l, small angular displacements from the optical axis l, or both. In one embodiment, at least one receiving surface 60 and at least one output surface 62 may be adjustable by actuating the alignment mechanism 68. Further, the user may adjust the individual outputs of the laser devices 32a-32c to intersect the optical axis l at the same point, or at various points. Those skilled in the art will appreciate that the multiple laser light source 10 may be manufactured having a laser devices 32a-32c approximately 1 mm to about 1 m from the beam director. For example, the laser devise 32a-32c may be located about 3 mm to about 20 mm from the beam director 14, thereby having an internal optical path length considerable shorter than systems presently available and minimizing alignment error in the system.

Optionally, one or more additional optical elements 70 may be positioned external of the of the multiple laser light source 10 and coupled to the housing 12 and/or the beam director 14. For example, one or more lenses may be used to focus the output laser light to a desired focal point. Exemplary optical elements include, without limitation, lenses, mirrors, gratings, filters, beam combiners, polarizers, fiber optic conduits, waveguides, prisms, beam splitters, optical crystals, and the like.

The foregoing description of various embodiments of a multiple laser light source is not intended to be exhaustive or to limit the invention to the precise forms disclosed.

What is claimed is:

1. A multiple laser light source, comprising:
a housing having a housing body defining at least one inner passage therein;
at least one laser support device configured to be coupled to the housing body;
two or more laser devices coupled to the laser support device each configured to output an optical signal; and
a beam director coupled to the housing body and configured to receive the optical signals from the laser devices and controllable output the optical signals to a desired focal point.

2. The device of claim 1 wherein the at least one laser device comprises a diode laser.

3. The device of claim 1 wherein the at least one laser device comprises a fiber laser.

4. The device of claim 1 wherein the at least one laser device is selected from the group consisting of solid state lasers, diode pumped solid state lasers, organic lasers, disc lasers, gas lasers, and vertical cavity surface emitting lasers.

5. The device of claim 1 wherein each laser device is configured to output an optical signal having about the same wavelength.

6. The device of claim 1 wherein at least one laser device is configured to output an optical signal having a different wavelength from at least one other laser device.

7. The device of claim 1 wherein each laser device is configured to output at about the same power.

8. The device of claim 1 wherein at least one laser device is configured to output an optical signal having a different power from at least one other laser device.

9. The device of claim 1 wherein the beam director further comprises at least one receiving surface configured to receive an optical signal from at least one laser device and at least one output surface configured to receive the optical signal from the receiving surface and direct at least a portion of the optical signal from the housing.

10. The device of claim 9 wherein the beam director further comprises at least one least one optical device receiver formed therein.

11. The device of claim 10 further comprising at least one optical device configured to be positioned within the optical device receiver, the optical device selected from the group consisting of shutters, modulators, prisms, lenses, filters, beam twisters, optical crystals, polarizers, mirrors, and gratings.

12. The device of claim 1 wherein the beam director is configured to have one or more additional optical elements coupled thereto, the additional optical element selected from the group consisting of lenses, mirrors, gratings, filters, beam combiners, polarizers, fiber optic conduits, waveguides, prisms, beam splitters, and optical crystals.

13. The device of claim 1 wherein the beam director further comprises at least one receiving surface and at least one output surface, the receiving surface configured to receive at least one output signal from at least one laser device and direct the signal to the output surface, the output surface configured to receive the output signal from the receiving surface and direct the output signal from the multiple laser light source.

14. The device of claim 13 further comprising at least one alignment mechanism configured to adjust the position of at least one of the receiving surface and the output surface.

15. The device of claim 1 further comprising at least one surface irregularity from on at least one of the housing and the laser support device, the surface irregularity configured to increase the surface area of the multiple laser light source thereby improving the cooling thereof.

16. The device of claim 1 wherein the laser devices are detachably coupled to the laser support device.

17. The device of claim 1 wherein the laser devices are non detachably coupled to the laser support device.

18. A multiple laser light source, comprising:
a housing having a housing body defining at least one inner passage therein;
at least one laser support device configured to be coupled to the housing body;
two or more laser devices coupled to the laser support device each configured to output an optical signal; and
a beam director coupled to the housing body and configured to receive the optical signals from the laser devices and output the optical signals to a desired focal point, the beam director having at least one receiving surface and at least one output surface formed thereon, the receiving surface and output surface in communication with at least one alignment mechanism permitting the user to adjust the output the optical signals.

19. The device of claim 1 further comprising at least one optical element coupled to the beam director and configured to controllably modulate the output.

20. A multiple laser light source, comprising:
a housing having a housing body defining at least one inner passage therein;
at least one laser support device configured to be coupled to the housing body;
two or more laser devices coupled to the laser support device each configured to output an optical signal;
a beam director coupled to the housing body and configured to receive the optical signals from the laser devices and output the optical signals to a desired focal point;
at least one receiving surface and at least one output surface formed on the beam director, the receiving surface and output surface in communication with at least one alignment mechanism permitting the user to adjust the output the optical signals; and
at least one optical element coupled to the beam director and configured to controllably modulate the output from the laser device.
